(19) United States
(12) Patent Application Publication
(10) Pub. No.: US 2010/0063674 A1
(43) Pub. Date: Mar. 11, 2010

(54) ENGINE TEST METHOD USING STRUCTURED TEST PROTOCOL

(75) Inventor: Dale W. Karolak, Brighton, MI (US)

Correspondence Address: HUSCH BLACKWELL SANDERS LLP, 190 Carondelet Plaza, Suite 600, ST. LOUIS, MO, 63105, US

(73) Assignee: ASSEMBLY & TEST WORLDWIDE, INC., Dayton, OH (US)

(21) Appl. No.: 12/208,606

(22) Filed: Sep. 11, 2008

(51) Int. Cl. G01M 15/05

(52) U.S. Cl. 701/35; 702/113

(57) ABSTRACT

A method of testing engines by evaluating operating parameters as dependent variables as a function of a respective independent variable. A failure rate is established for at least some of the operating parameters as judged against pass/fail specifications. A test sequence for operating parameters is established prioritizing at least one high failure rate operating parameter in the test sequence.

### BACKGROUND OF INVENTION

Some internal combustion engines are subjected to numerous tests by their manufacturer prior to sale. The tests are conducted to determine whether or not various components of the engine are operating within specification and therefore acceptable for sale. For example, an engine may be tested for oil pressure, engine compression, intake and exhaust manifold pressure, engine friction, fuel pressure, glow plug operation and the like. Some engines will be tested for multiple operating parameters. Sometimes as many as about twenty components/systems are evaluated. The tests are conducted in a sequence and are currently tested by running through the complete set of tests before it is determined whether or not an engine has passed or failed. Because of the number of tests, and the length of time some of the tests take, the total test period can be quite lengthy and therefore expensive and more so if one or more tests are repeated. Some tests may be performed simultaneously, for example, each of the cylinder pressures may be tested as a group, generally simultaneously. However, group testing has not significantly shortened the total test period. Additionally, some tested operating parameters are significantly more important than other parameters. For example, oil pressure is a more critical operating parameter than, for example, ignition voltage. Also, the failure rates will vary by the operating parameter (engine component) and the failure rates for various operating parameters (engine components) may change over time depending on the manufacturing process and component parts used.

A method and apparatus for testing automotive components are disclosed in co-pending patent application filed Sep. 11, 2008 as Ser. No. 12/208,503 and entitled Method And Apparatus For Testing Automotive Components, the entire disclosure of which is incorporated herein by reference.

There is thus a need for an improved method of testing engines that will improve testing efficiency.

### SUMMARY OF INVENTION

The present invention involves the provision of a method of testing an engine for a plurality of different operating parameters (dependent variables). The method includes providing data indicative of failure rate of an engine component as indicated by measured operating parameters and the time needed to perform an operating parameter test on the engine. The data is stored and analyzed to determine an order sequence based on failure rate for an engine component and/or criticality of the operating parameter (severity of defect) and/or test data analysis time. Tests for the operating parameters are conducted in a sequence based on the determination. From time to time, additional data is gathered and analyzed to possibly reorder the test sequence for values of the dependent variables.

### BRIEF DESCRIPTION OF DRAWINGS

FIG. 1 is a simplified schematic view of an engine test apparatus.

FIG. 2 is a flow chart illustrating the method of the present invention.

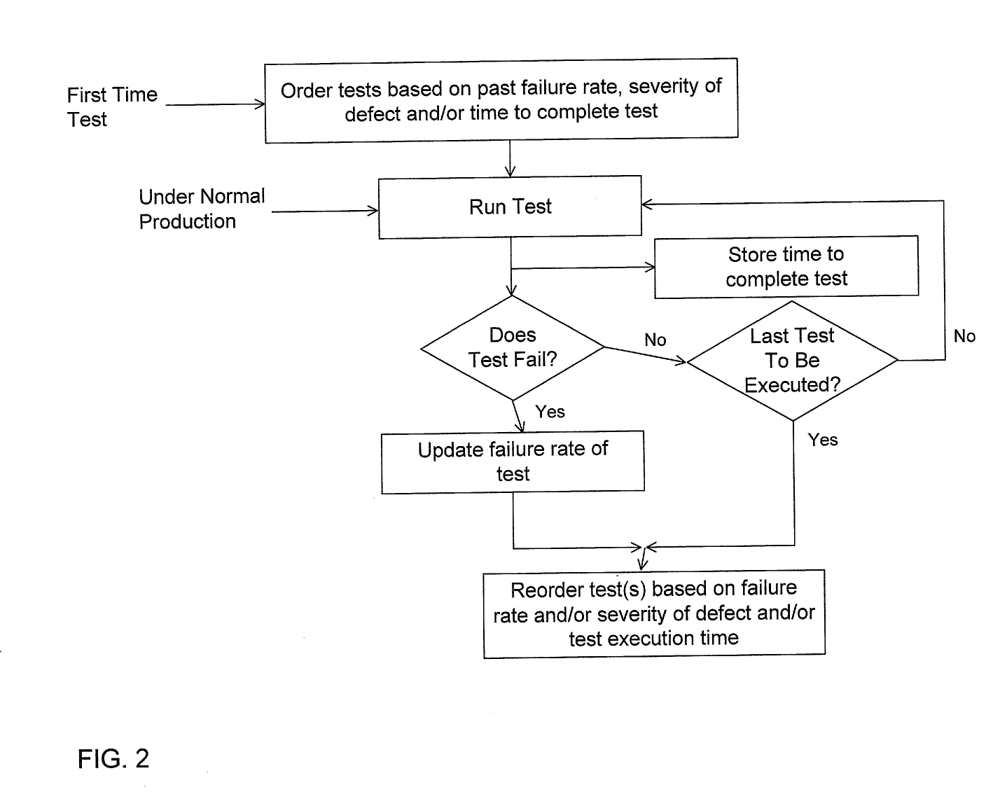

Like numbers throughout the various Figures designate like or similar parts and/or construction.

### DETAILED DESCRIPTION

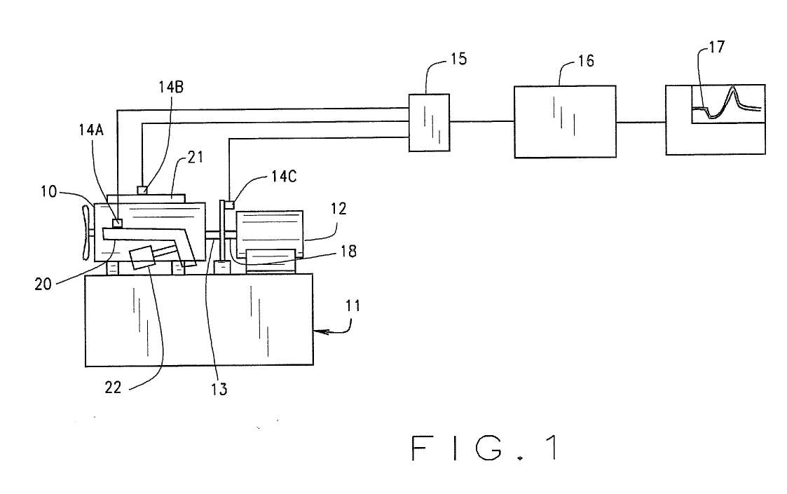

A process is provided for testing an internal combustion engine to determine if certain components of the engine are within specification. As best seen in FIG. 1, the engine 10, which is shown as a piston type internal combustion engine, is mounted to a test stand 11 and operably coupled to a drive device 12 such as an electric motor. A plurality of sensors 14A, 14B, 14C are associated with the engine and/or drive device to sense certain operating parameter values. The sensed or measured operating parameters can include both those related to dependent and independent variables. For example, sensor 14C can be an angle encoder for crankshaft 13 and/or tachometer. Engine friction which can be measured for example by sensing the amperage draw of the drive device 12 or the use of a torque meter. The crankshaft 13 is coupled to and output shaft 18 of the drive device 12. The tests for an engine approval are typically conducted without the engine running on its own but being driven by a drive device 12. The test apparatus can be provided with an automated data collection system 15 which is operable to provide signals indicative of the values of certain operating parameters to a data processing system 16 such as a personal digital computer having both a memory and a processor. An output device 17 can also be provided, such as a display monitor and/or printer. Such systems are known in the art as engine cold test machines and are available from Assembly & Test Worldwide, Inc. of Livonia, Mich. The data processing system 16 can be provided with means to effectuate the testing of the engine in an automated or semi-automated manner instructing the operation of the drive device 12 and selecting the operating parameter data collection and sequence of collection. The data processing system 16 can be programmed to automatically determine whether or not an operating parameter is within or outside specification.

The method of the present invention involves selecting a set of operating parameters to be tested as dependent variables. Such dependent variable parameters for an internal combustion piston engine could include exhaust manifold 20 and intake manifold 21 pressures, cylinder pressure, oil pressure, oil FFT and order, glow plug resistance/operation, spark voltage, fuel system injection pressure and timing, engine friction (breaking and running), engine balance, turbocharger 22 pressure, variable valve timing, vibration and the like for the dependent variables. Independent variables can include time, engine crankshaft rotational position as measured, e.g., by an angle encoder and engine angular velocity (RPM).

A study is conducted to determine the failure rate or the out of specification rate for a particular operating parameter for a particular type or model of engine. The study can also include evaluation of severity of defect, the time to conduct the test for a particular operating parameter and an evaluation of the amount of variation in an operating parameter value during the test. For those operating parameters that have little, if any change, for example engine friction or engine balance, the test for such a parameter can be simplified as it does not necessarily need to be correlated to an independent variable for example, the rotational or angular position of the crankshaft, test time or angular velocity of the crankshaft.

The data processing system 16 is preferably programmed with acceptance/rejection criteria for each of the operating parameters and is operable to determine if an operating parameter is in or out of specification. The data gathered during a test can be compared to the programmed acceptance/rejection criteria and a determination made whether or not the operating parameters are within or outside of specification. The results of the analysis may be displayed graphically on a display monitor 17 or may be disseminated via a printout from a printer. Some operating parameters will have a complex analysis needed, particularly when the operating parameter varies significantly over the test cycle. For example, cylinder pressure will vary widely depending upon the position of a piston within the cylinder as determined by the degree of rotation of the crankshaft within the engine. Such an analysis can be complex to determine whether nor the cylinder pressure is within specification throughout the test cycle or a portion of the test cycle. The analysis may also provide information about the cause of an out of specification condition. An analysis of this type of parameter can be very lengthy as opposed to engine friction which would typically show a substantially uniform value throughout a test cycle. If the engine to be tested is a so-called four stroke engine, two complete revolutions of the engine would be a test cycle since this is one complete cycle of the engine for one cylinder. For a multi cylinder engine, more than two revolutions may be required.

An independent variable is selected to correlate to at least some of the operating parameters (dependent variables), particularly those that change through an operating cycle. The data collected for the operating parameter is then correlated to the independent variable for testing and analysis purposes. The obtained test data for an operating parameter is analyzed as a function of the independent variable, for example the degree of rotation of the crankshaft or time. Initially, test data is analyzed to determine, statistically, the failure rate of various engine components to be tested for each operating parameter. An evaluation may also be provided for the severity of the defect which may be established by statistical analysis or experience and may be given arbitrary scale values, e.g., 1 for low severity and 5 for critical severity. For example, low oil pressure could be a severe defect and hard to remedy and assigned a value of 4 while spark plug voltage would be a non-severe defect that is also easy to fix and assigned a value of 1. If an operating parameter is found out of specification and has no impact on other operating parameters, the remaining engine components may be tested without first sending the engine for repair. The data processing system 16 may be programmed to automatically or manually accomplish this. An analysis can also be provided of the time it takes to perform a test for an operating parameter and the time needed to analyze the obtained data. The analysis of the data is stored in the data processing system 16 memory for a purpose later described.

In the process of testing an engine component, test protocols are established. Those protocols can be, for example, the angular velocity of the engine crankshaft, operating temperature, humidity, type of lubricant, test equipment, sensors, the frequency of taking data points for a particular operating parameter, the number of operating cycles (engine revolutions) over which an operating parameter will be evaluated and the like.

The data processing system 16 can be programmed to automatically conduct the test of operating parameters providing commands to effect sensor operation and operation of drive device 12.

The analysis of historical test data can be utilized to establish not only the test protocol for an operating parameter, but also a testing sequence for the various operating parameters. Up to three factors, or even more, can be considered in establishing a test sequence for various operating parameters. The primary factor is preferably failure rate for a given engine component as tested by its operating parameter as a dependent variable. Preferably, the secondary factor is the severity of the possible defect. The tertiary factor is preferably time to conduct the test and/or analyze test data for a given operating parameter. The historical data can be analyzed to determine an initial sequence of testing for the various operating parameters. For example, if cylinder pressure has the highest failure rate, it may be tested for first. However, if a lower failure rate is found in oil pump pressure but it is provided with a higher severity rating, it may be tested for first since it is a more critical operating component. Preferably though, the tests are conducted generally in the order of descending level of failure rate. Thus, when the failed component is identified, the engine can be sent to rework without completing the entire test procedure. The engine may be retested after repair skipping previously tested operating parameters if they were within specification in a prior test of the engine and the repair of the defect is not likely to have an effect on the components that have passed testing. Data from additional operating parameter tests can also be provided after a test shows an out of specification operating parameter which might indicate the potential cause of the problem, for example, engine friction may be looked at in combination with cylinder pressure which might indicate defective rings. Instructions for such additional testing can be programmed in the data processing system 16. Thus, even though the tests could be stopped at cylinder pressure, a secondary test could be conducted to help analyze the cause of the failure. This can simplify the repair process as well as reduce the time needed to conduct the tests.

In the testing of operating parameters, each operating parameter may be tested individually and in a predetermined sequence. It is to be understood though, that multiple operating parameters may be tested simultaneously in a group. For example, a multi-channel data collection system 15 can be provided that would permit, for example, testing for intake and exhaust manifold pressures as well as cylinder pressures simultaneously since they are all linked to rotational position of the crankshaft. Likewise, the cylinder pressure of each cylinder may be checked simultaneously by providing multiple pressure sensors, one in each cylinder. Simultaneous testing may also provide information regarding the possible cause of the failed test and these operating parameters may be tested for in a group. A group of operating parameters preferably includes at least one prioritized operating parameter establishing the position of the group in the overall testing order. The makeup of a group can be based on relatedness of the operating parameters, e.g., all cylinder pressures and also intake and exhaust manifold pressures. More than one prioritized operating parameter may be included in a group.

New historical data may be generated over time, from the individual engine tests to update data on the failure rates, time to conduct the analysis or tests and the severity of a defect. This data can then be analyzed to update the testing sequence as described above. The data processing system 16 can then provide output to an operator or automatically to effect a change in the testing sequence, testing procedure and/or protocol.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of testing an engine for a plurality of different operating parameters, the method comprising:
providing data indicative of at least one of failure rate of engine components as indicated by measured operating parameter values, time to perform a test of each of a plurality engine operating parameters and severity of defect;
storing said data;
analyzing said data and determining an order sequence of operating parameter test performance; and
conducting the tests of operating parameters for an engine in a priority sequence based on the determination.

2. The method of claim 1 including collecting further operating parameter data after a test sequence is established and evaluating the test sequence for possible change based on analysis of the further operating parameter data.

3. The method of 2 including assigning a severity of defect value to at least two operating parameters and considering said severity of defect values in making said test sequence determination.

4. The method of claim 3 wherein an operating parameter having a higher severity of defect value being tested prior to an operating parameter having a lesser severity of defect value.

5. The method of claim 1 wherein the sequence of tests being conducted generally in descending order of engine component failure rate.

6. The method of claim 5 including collecting further operating parameter data after a test sequence is established and evaluating the test sequence for possible change based on analysis of further data.

7. The method of claim 6 including determining a new order sequence based on a change in failure rate.

8. The method of claim 1 including grouping selected operating parameters in a group and gathering data for the grouped operating parameters in as a group and prioritizing the position of the group in the test sequence based on the priority of at least one operating parameter in the group.

9. The method of claim 8 wherein at least some of the operating parameters in the group being related.
